(19) United States
(12) Patent Application Publication
(10) Pub. No.: US 2016/0348572 A1
(43) Pub. Date: Dec. 1, 2016

(54) ASSEMBLY INCLUDING A HEAT ENGINE AND AN ELECTRICAL COMPRESSOR CONFIGURED SUCH AS TO SCAVENGE RESIDUAL BURNT GASES

(71) Applicant: VALEO SYSTEMES DE CONTROLE MOTEUR, Cergy Saint Christophe (FR)

(72) Inventors: Sébastien Potteau, Triel Sur Seine (FR); Pascal Menegazzi, Sartrouville (FR)

(73) Assignee: Valeo Systemes de Controle Moteur, Cergy Saint Christophe (FR)

(21) Appl. No.: 15/106,513

(22) PCT Filed: Dec. 18, 2014
(86) PCT No.: PCT/FR2014/053419

§ 371 Date: Aug. 23, 2016

(30) Foreign Application Priority Data
Dec. 19, 2013 (FR) 1362995

(51) Int. Cl. F02B 25/14; F02B 35/02; F01L 1/34; F02B 37/04; F02M 35/10; F02B 17/00; F02B 33/40; F02B 39/10

(52) U.S. Cl. CPC F02B 25/145; F02B 33/40; F02B 35/02; F02B 39/10; F02B 37/04; F02M 35/10157; F02M 35/10255; F02B 17/005; F01L 1/34

(57) ABSTRACT

This invention relates to an assembly comprising: an intake pipe (4) extending between an air inlet (11) and a combustion engine (2), a combustion engine (2), an electric compressor (5) arranged on the intake pipe upstream of the combustion engine (2), a valve (8) arranged upstream of the combustion engine (2), the electric compressor (5) being configured to enable the residual burnt gases to be scavenged.

This invention relates to the field of combustion engines, and more particularly to an assembly for a combustion engine of a motor vehicle comprising an air intake system and an electric compressor configured to improve scavenging of residual burnt gases.

Currently, in direct-injection petrol turbo engines, scavenging is used to eliminate residual burnt gases in order to reduce their concentrations and thus improve engine performance, particularly in respect of knocking. In fact, residual burnt gases cause knocking because they increase the temperature of the mixture during compression of the fresh air and fuel. These residual burnt gases also restrict the extent to which the engine can fill with air by taking the place thereof.

In petrol engines, scavenging is chiefly used at low speed and heavy load because, in this zone, the exhaust pressure is lower than the intake pressure, which allows the gases to circulate from the intake to the exhaust. To achieve this, the intake and exhaust valves are opened at the same time.

One of the problems with this technique is that it is necessary to wait for the turbocharger to start up before scavenging can begin. In fact, the turbocharger has a certain response time (known as turbo-lag) during which the enthalpy of the exhaust gases is not yet sufficient to run the turbine of the turbocharger at the ideal speed. Moreover, scavenging can only occur in the zone of low speed and high load because it is only in this zone that scavenging is possible, which limits the extent of the zone.

The aim of this invention is therefore to overcome one or more of the drawbacks of the systems of the prior art by proposing an assembly for a combustion engine comprising an electric compressor to improve the elimination of the residual burnt gases and to prevent knocking that results from the presence of these gases in large quantity.

To this end, the invention proposes an assembly comprising:
an intake pipe extending between an air inlet and a combustion engine,
a combustion engine,
an electric compressor arranged on the intake pipe upstream of the combustion engine,
a valve arranged upstream of the combustion engine,
the electric compressor being configured to enable the residual burnt gases to be scavenged.

According to an embodiment of the invention, the electric compressor is equipped with a variable reluctance motor.

The use of an electric compressor according to the invention overcomes the need to wait for the turbocharger to pick up speed. It is thus possible to scavenge across a wider zone and at lower loads.

Using an electric compressor also has the advantage of enabling fresh air to be scavenged in the pollution zone. This allows air to be injected at the exhaust, which enables a faster increase in temperature of the catalytic converter.

According to an embodiment of the invention, the assembly comprises a variable valve timing system.

According to an embodiment of the invention, the electric compressor is integrated into a bypass circuit comprising a bypass means configured to direct the intake air through the electric compressor during a transient phase.

According to an embodiment of the invention, the assembly comprises a direct-injection system.

Thus, using an electric compressor with a variable valve timing system and a direct injection system increases the limit for knocking at low speed, extends the scavenging zone for high loads and allows air to be injected at the exhaust.

The invention also concerns a method of operating an assembly according to the invention comprising, during an operating mode with the engine at low speed:
a step of activating the electric compressor,
a step of circulating the intake air through the electric compressor,
a step of scavenging the unburnt residual gases of the engine.

According to an embodiment of the invention, the method comprises a step of regulating the flow of intake air by means of a valve.

The invention also concerns the use of an assembly according to the invention in order to scavenge the unburnt residual gases of the engine.

According to an embodiment of the invention, the assembly is used during a low speed engine operating mode of a vehicle.

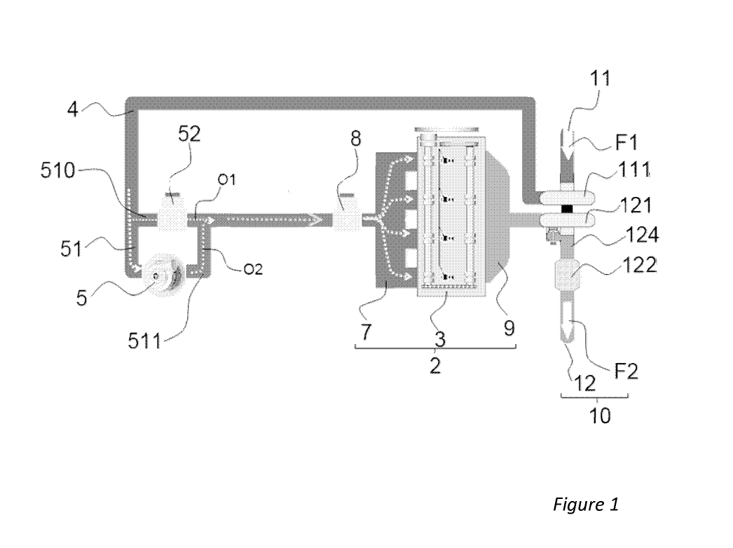

Further aims, features and advantages of the invention will be better understood and emerge more clearly from the following description, referring to accompanying FIG. 1, given by way of example, and which is a partial schematic representation of an engine architecture including an electric air compressor according to the invention.

This invention relates to an assembly comprising a combustion engine, an air intake system and an electric air compressor.

This invention concerns all combustion engines, diesel, petrol, gas, ethanol or a mixture of these constituents, whether supercharged or not.

In the following description, an electric compressor means an air compressor, whether positive-displacement or not and for example centrifugal or radial, driven by an electric motor, with the aim of supercharging a combustion engine.

According to an embodiment of the invention the compressor is an air-supercharged compressor.

According to an embodiment of the invention, the electric motor of the electric compressor is a direct- or alternating-current, synchronous motor or any type of electric motor of the same type.

More precisely, according to an embodiment of the invention, the electric motor is a variable reluctance motor (also called a Switched Reluctance Motor, or SRM).

The electric compressor is therefore usually activated to increase the density of the intake air. Within the scope of the invention, the electric compressor is associated with a bypass circuit enabling it to be bypassed if necessary, as described below.

Within the scope of the invention, the electric compressor is arranged upstream of the combustion engine.

According to an embodiment of the invention, the combustion engine is a two-stroke engine.

According to an embodiment of the invention, the combustion engine is a four-stroke engine.

According to an embodiment of the invention, the assembly according to the invention comprises at least one catalytic converter arranged at the outlet of the combustion engine, on the exhaust system.

According to an embodiment of the invention, the assembly comprises several catalytic converters.

According to an embodiment of the invention, the assembly according to the invention comprises a Variable Valve Timing (VVT) or Variable Valve Lift system.

Within the scope of the invention, an electric compressor is used during the low speed engine operating mode and when the engine is operating under low or high load.

Low speed means an engine operation of between 1000 and 3000 rpm, and low or high loads mean the fact that the engine operates at 10 to 90% of its load.

Using an electric compressor according to the invention overcomes the need to wait for the turbocharger to pick up speed. It is thus possible to scavenge across a wider zone and at lower loads.

Using an electric compressor also has the advantage of enabling scavenging with fresh air in the pollution zone. This allows air to be injected at the exhaust, which enables a faster increase in temperature of the catalytic converter.

Thus, using an electric compressor with a variable timing system and a direct injection system enables:
the limit of knocking at low speed to be increased and the scavenging zone for high loads to be extended. In fact, during scavenging at high load, using an electric compressor enables scavenging to be increased during intake and exhaust valve overlap, in other words when the intake and exhaust valves are open at the same time.
Air to be injected at the exhaust still on the same principle but this time at low loads to enable faster actuation of the catalytic converter. Using an electric compressor thus also has the advantage of reducing engine warm-up time. This makes it possible to reduce the use of precious metals in the catalytic converter and/or to allow its thermal stresses to be limited by installing it further down the exhaust system.

The assembly concerned by this invention, an embodiment of which is shown in FIG. 1, comprises a combustion engine 2 with an intake pipe 4 and an electric compressor 5.

This engine 2 comprises an engine block 3 comprising a plurality of cylinders, four in the FIGURE, designed to receive a mixture of combustion agent and fuel, for example petrol as fuel and pure air or a mixture of air/recirculation gas as combustion agent.

Combustion in the cylinders causes the engine 2 to work. The operation of the engine is conventional: the air is taken into the cylinders, is compressed there, burnt then expelled in the form of exhaust gas.

This engine 2 has an inlet connected to the intake pipe 4 and an outlet connected to an exhaust gas circuit 10.

The inlet 11 of the intake pipe 4 defines the inlet through which the fresh intake air penetrates into the assembly, whereas the outlet 12 of the exhaust circuit 10 defines the outlet through which the exhaust gases are evacuated from the assembly.

The intake pipe 4 opens into an intake manifold 7 that thus forms an inlet case for the air taken into the combustion chamber 3 of the engine 2.

Intake pipe 4 means the intake pipeline for the intake air, whose flow is represented by the arrow F1, this pipeline being located between the inlet 11 and the engine 2.

According to an embodiment of the invention, the intake pipe 4 comprises a mechanical compressor 111 of the intake air.

According to an embodiment of the invention, upstream of the intake manifold 7 for admitting the air into the engine 2, the intake pipe 4 comprises a valve 8 comprising a butterfly shut-off valve that serves to regulate the flow of intake air in order to regulate engine speed. This valve 8 is controlled by an Engine Control Unit (ECU), well known to a person skilled in the art, and regulates the amount of air introduced into the engine and necessary for combustion.

The outlet of the engine 2 is formed by an exhaust gas manifold 9. This is connected to an exhaust gas channel or pipe 124 forming part of the exhaust gas circuit.

According to an embodiment of the invention, the exhaust circuit 10 comprises a turbine 121 rotationally fixed to the mechanical compressor 111 of the intake air and forming therewith a turbocharger. The turbine 121 is driven by the exhaust gases of the exhaust pipe 124, whose flow is schematically represented by the arrow F2. According to an embodiment, this flow passes through the catalytic converter 122.

As shown in FIG. 1, the assembly comprises an electric compressor 5. This compressor 5 is driven by an electric motor, not shown, which is controlled for example by the engine control unit. The electric compressor 5 is arranged in the loop of the intake pipe 4.

In a first variation of the invention, the electric compressor 5 is arranged upstream of the butterfly valve 8.

In a second variation of the invention, not shown, the electric compressor 5 is arranged downstream of the butterfly valve 8.

According to an embodiment of the invention, the electric compressor is integrated into a bypass circuit 51 comprising a valve-type bypass means 52. This valve 52 is for example a butterfly valve. This valve 52 is for example controlled by the engine control unit. The bypass circuit 51 in association with the bypass means 52 generally allows the intake air arriving via the intake circuit 4 to circulate through the electric compressor or to bypass it, by closing or opening the bypass means 52. The valve-type bypass means 52 is arranged on a first pipe 510 of the bypass circuit 51, different from that of the electric compressor 5, so that when the valve is closed, the intake air O2 is directed towards the second pipe 511 where the electric compressor 5 is arranged.

Thus, outside the operating phases of the engine where the compressor is used, and within the scope of the invention outside low speed phases, the intake air O1 circulates in the first pipe 510 and does not pass through the electric compressor 5.

The operation of the assembly according to the invention is as follows.

During a transient operating mode of the engine at low speed, the electric compressor is activated via the engine control unit and compresses the intake air circulating in the intake pipe.

This compressed air is then sent directly into the engine 2 via the butterfly valve 8.

Scavenging is then performed in a conventional manner. The intake gases “push” the unburnt residual gases, which are then evacuated. This is possible because the intake and exhaust valves are open.

The phase of using the electric compressor according to the invention, namely at low speed, can then be followed by an established phase according to which the assembly is controlled so that the electric compressor is not fed.

This method of controlling an assembly as defined above thus enables, during an operation of the engine at low speed, the electric compressor to be activated and with the aid thereof all or part of the intake air circulating in the intake pipe to be compressed, which allows the air flow to be increased more rapidly and promotes more rapid scavenging.

The scope of the present invention is not limited to the details given above and allows embodiments under numerous other specific forms without departing form the scope of protection of the invention. Consequently, the present embodiments must be deemed as being given by way illustration and can be changed without, however, departing from the scope defined by the claims.

1. An assembly comprising:
an intake pipe extending between an air inlet and a combustion engine;
the combustion engine;
an electric compressor arranged on the intake pipe upstream of the combustion engine; and
a valve arranged upstream of the combustion engine,
the electric compressor being configured to enable the residual burnt gases to be scavenged.

2. The assembly according to claim 1, further comprising a variable valve timing system.

3. The assembly according to one of claim 1, wherein the electric compressor is integrated into a bypass circuit comprising a bypass means configured to direct the intake air through the electric compressor during a transient phase.

4. The assembly according to claim 1, comprising a direct-injection system.

5. The assembly according to claim 1, wherein the electric compressor is equipped with a variable reluctance motor.

6. A method of operating an assembly according to claim 1, comprising, during an operating mode with the engine at low speed:
activating the electric compressor;
circulating the intake air through the electric compressor; and
scavenging the unburnt residual gases of the engine.

7. The method according to claim 6, further comprising a regulating the flow of intake air by means of a valve.

8. A use of an assembly according to claim 1, to scavenge the unburnt residual gases of the engine.

9. The use of an assembly according to claim 8, during a low speed engine operating mode of a vehicle.
